(19) United States
(12) Patent Application Publication
(10) Pub. No.: US 2026/0307899 A1
(43) Pub. Date: Oct. 8, 2026

(54) AUTOMATED HIGH-DENSITY STORAGE SYSTEM, AND METHOD FOR STORING AND RETRIEVING CONTAINERS

(71) Applicant: Holger HUMBURG, Hanau (DE)

(72) Inventor: Holger HUMBURG, Hanau (DE)

(21) Appl. No.: 19/472,673

(22) PCT Filed: Mar. 19, 2024
(86) PCT No.: PCT/EP2024/057311

§ 371 Date: Oct. 5, 2025

(30) Foreign Application Priority Data
Apr. 11, 2023 (EP) 23167321.1

(51) Int. Cl. B65G 1/06; B65G 1/04

(52) U.S. Cl. CPC B65G 1/065; B65G 1/0478; B65G 2201/0235

(57) ABSTRACT

The invention relates to an automated storage system (1) and a method forstoring and retrieving containers (5) in such a storage system. For this purpose, the storage system (1) is equipped with at least one rack (2a, 2b), arranged parallel to an aisle (3) comprising at least one level with a plurality of channels (4) arranged transversely to the aisle (3), as well as at least one aisle vehicle (6) that can move within the aisle (3) and a control unit for the autonomous movement of at least one aisle vehicle (6). The channels (4) are inclined relative to the horizontal in such a way that the end of each channel (4) facing the aisle (3) lies vertically below the end of the respective channel (4) facing away from the aisle (3). According to the invention, the aisle vehicle (6) comprises a shuttle vehicle (7) that is designed and configured to store containers (5) into the channels (4) by moving relative to the aisle vehicle (6) and transversely to the aisle (3) into the channels (4).

The invention relates to an automated storage system and to a method for storing and retrieving from containers in such a storage system.

Automated storage systems are used in modern logistics processes for picking, buffering, sequencing goods and orders and for supplying workstations. In this context, shuttle systems are used in automated small-parts warehouses, which, from a plurality of generally identical containers stored in a rack, pick up one container and convey it to a transfer or processing station. In the same manner, the containers are re-sorted into the rack by means of the shuttle systems.

Basically, pure shuttle systems are known in which the conveyed goods rest in a shelf rack or on static rails and are picked up by an aisle vehicle, predominantly by means of a push/pull device, in a single-deep, double-deep, or, more rarely, multi-deep manner. These systems achieve a very high throughput, as long as they do not first have to clear out the last container. Such shuttle systems are offered, among others, by (Graz), Dematic (Heusenstamm) and TGW (Linz).

Furthermore, a system exists under the designation AutoStore, in which the channels are arranged vertically and vehicles travel on top of the rack. When it is necessary to clear out the vertical channel in order to access the lower containers, the upper travel path around the channel in use becomes filled with containers, thereby obstructing the unobstructed material flow of the devices traveling on top. A modular storage and order-picking installation is known, for example, from DE 10 2017 129 120B4 . In this case, a rack-like storage unit has a plurality of levels one above the other, each comprising a plurality of channels in which a plurality of containers can be placed. Each of the channels is designed as a roller conveyor and is arranged at an incline relative to the horizontal, so that containers in the channels roll or slide towards the lower end under the effect of gravity. The length of the channels is dimensioned such that, for example, five containers can be accommodated in each channel.

On both sides of the rack-like storage unit, a conveying unit is provided in which shuttle vehicles can travel between the individual levels and between the individual channels. Containers are removed from the rack-like storage unit by one of the two conveying units, in each case from the lower end of the respective channel. The storage of containers is carried out by means of the other conveying unit, in which individual containers are inserted into the higher end of the respective channel and, if the channel is not yet completely filled with containers, roll or slide toward the lower end under the effect of gravity.

If the requested container is not located at the foremost position of the channel, the conveying unit first removes all containers positioned in front of it one after the other and places them on a return conveyor. Alternatively, it is possible to arrange some of the channels in groups with opposite directions of inclination, so that, if the requested container is not located at the foremost position of the channel, the conveying unit first removes all the containers positioned in front of it one after the other and deposits them at the upper end of a free channel oppositely inclined channel.

Starting from this prior art, it is a task of the present invention to provide an automated storage system which, with comparable space requirements and comparable access speed, is capable of accommodating a larger number of containers.

This task is solved by means of a storage system having the features of claim 1 and by means of a method having the features of claim 13.

An automated storage system according to the invention essentially comprises at least one rack, at least one aisle vehicle and a control system. The at least one rack is arranged parallel to an aisle and comprises at least one level, preferably a plurality of levels which may be connected by at least one lift or hoist, with a plurality of channels arranged transversely to the aisle. The channels are oriented at an inclination relative to the horizontal in such a way that the end of each channel facing the aisle lies vertically below the end of the respective channel facing away from the aisle. The aisle vehicle is movable in the aisle along the ends of the channels facing the aisle in order to enable the removal of containers from the channels. The control unit is designed and configured for autonomous travel of the at least one aisle vehicle.

The invention is based on the concept that the storage density of the containers can be increased if the aisle vehicle is used not only for removing containers from the channels, but also for storing containers in the channels. For this purpose, the aisle vehicle comprises a shuttle vehicle which is designed and configured for storing containers in the channels, and which is capable of travelling relative to the aisle vehicle and transversely to the aisle into the channels. This can be achieved, for example, by means of a form-fitting contact between the shuttle vehicle and the channel.

Compared with pure shuttle systems, the inventive solution, in which the shuttle vehicle travels uphill in the channel, has the advantage that only the first container of the channel needs to be removed, and while the aisle vehicle is moving to the lift or to a parking position, the other containers of the channel from which the container was taken roll or slide downhill on their own to the channel end stop. In other words, the shuttle vehicle can drive a container uphill within the inclined channel and, in doing so, push any further containers in the channel uphill as well. Thus, the storage of the containers does not take place, as in the prior art, at the upper end of an inclined channel, but rather at the lower end of the channel and therefore at the point where the aisle vehicle travels.

In this way, it is possible to dispense with the operation from both sides of the channels required in the prior art and to store containers into the channels and remove them therefrom from a single aisle. Thus, with comparable space requirements, a higher density of stored containers can be achieved. In addition, the access speed is improved compared with known solutions employing a return conveyor.

In order for the shuttle vehicle to be able to travel uphill within an inclined channel and, in doing so, also to displace containers present in the channel against the force of gravity, it is preferred that the shuttle vehicle is drivable and has sufficient traction, for example by means of a form-fitting contact with the channel. For this purpose, each channel may comprise at least one rack extending transversely to the aisle, into which at least one drivable gear wheel of the shuttle vehicle can engage. Preferably, two racks are provided per channel, and the shuttle vehicle has two or four gear wheels whish engage with the racks. The two or four gear wheels are in engagement with the racks of the channel only when they are located within the channel. Otherwise, the gear wheels are in engagement with racks provided on the aisle vehicle. The shuttle vehicle may also be equipped with a caterpillar drive and tooth profile for a continuous frictional connection. Alternatively, other types of drive are suitable, for example a shuttle vehicle with rubber-coated drive wheels or drive wheels or with Vulkollan, which travels on a roadway that may, if necessary, be designed with sufficiently roughness.

According to a further alternative, the shuttle vehicle can be supported on the aisle vehicle and be moved relative thereto hydraulically and/or pneumatically. The combination of the aisle vehicle and the shuttle vehicle can also be configured in the manner of a storage and retrieval device (so-called miniload) of an automated small-parts warehouse (AS/RS). In other words, the aisle vehicle and the shuttle vehicle do not have to be separate vehicles, but may be formed as components of a single vehicle that are movable relative to one another. In this way, a simple miniload with forks can cover all levels and likewise remove containers from the channels and push them into the channels. This embodiment of the invention, in which the aisle vehicle and the shuttle vehicle are configured in the manner of a storage and retrieval device of an automated small-parts warehouse, however, entails a lower throughput capacity. In return, the separate aisle vehicles on each level as well as the lifts at the end of the aisle are are dispensed with. The same function at lower costs and throughput capacity is also achieved with a miniload having a separate, co-travelling shuttle vehicle.

It has proven advantageous if the channels are oriented at an inclination of 1° to 3° relative to the horizontal, in particular at about 1.8°. This corresponds to a gradient of, for example, 4%.

A storage system in which containers can be stored with particularly high density can be realised in that the length of the channels is matched to the size of the containers to be stored and retrieved in such a way that each channel can accommodate between about five and about twelve containers, preferably eight to ten containers.

If the channels are designed as roller conveyors, wheel conveyors and/or ball conveyors, the containers can be moved smoothly within the channels. At a gradient of, for example, 4%, the containers then also roll or slide automatically towards the lower end of the respective channel.

In the automated storage system, rails can extend in each level parallel to the aisle, on which the aisle vehicle is movable. The aisle vehicle is preferably configured to travel, rail-guided, only along the aisle. In other words, lifting devices that could move the aisle vehicle between different levels are dispensed with, and the aisle vehicle also does not have to be able to travel transversely to the aisle due to the properties of the shuttle vehicle. This permits a robust and simple construction that enables low-failure operation.

According to a preferred embodiment of the storage system, at least one intermediate conveyor, for example a conveyor belt, is provided in each level. Additionally or alternatively, in a storage system in which the rack has a plurality of levels arranged one above the other, at least one lift may be provided which is designed and configured to transfer containers between the levels. The intermediate conveyor, for example, takes over containers from the aisle vehicle or from the shuttle vehicle and delivers them to the lift or vice versa. In this case, the intermediate conveyor can assume the function of a buffer store, so that the aisle vehicle does not have to wait for the lift.

In a preferred example, a lift is provided for each rack at one end of the storage system, Le. at one end of the aisle, and a intermediate conveyor is provided on each level. This makes it possible that, in case of two racks provided on both sides of the aisle, one lift together with the intermediate conveyors provided on each level transport containers to be stored to the shuttle and aisle vehicles of the respective level, whereas the other lift together with the intermediate conveyors provided on each level takes over containers to be retrieved from the shuttle and aisle vehicles of the respective level. According to a further alternative, the combination of aisle vehicle and shuttle vehicle can perform aisle changes between different levels by means of an additional lift, e.g. at the front of the rack. In this embodiment, the same function is achieved at lower throughput capacity and lower costs.

The shuttle vehicle can be connected to the aisle vehicle via a power supply line and/or signal line. The aisle vehicle can be connected to a power source via conductor rails. According to one embodiment, the shuttle vehicle and the aisle vehicle are connected by a retractable cable for power supply, for example a 48V line, as well as by a signal line. The power supply line and/or signal line can also be replaced by a battery or a SuperCap (capacitor) carried along in the shuttle vehicle and/or wireless signal exchange. The aisle vehicle can also be operated with 48V and is supplied, for example, by a simple 2-pole conductor rail. It is preferred in this case if the shuttle vehicle and the aisle vehicle each have drive motors that are independent of one another.

The shuttle vehicle may comprise a lifting device by means of which a container can be raised within a channel for storage and/or retrieval. As an alternative, a container can also be gripped and transported by the aisle vehicle by means of a fork or similar.

For a high storage density, it is preferred if, in the automated storage system, a rack is provided on each side of the aisle. The channels of both racks can be oriented at an inclination relative to the horizontal in such a way that the end of each channel facing the aisle lies vertically below the end of the respective channel facing away from the aisle. In a preferred embodiment, the shuttle vehicle can be moved into the channels of both racks, i.e. in both directions transverse to the aisle. In other words, an aisle vehicle together with a shuttle vehicle can serve one level of both racks.

In a method according to the invention for storing and retrieving containers in an automated storage system of the type mentioned above, the retrieval of a container from the rack is carried out, for example, by the following steps: an aisle vehicle together with a shuttle vehicle arranged thereon is moved in the aisle to the end of the channel facing the aisle in which the container to be retrieved is located, then the shuttle vehicle is moved from the aisle vehicle into the channel, where it picks up the first container of the channel located closest to the aisle, and subsequently returns together with this first container onto the aisle vehicle. If the first container is already the container to be retrieved, the aisle vehicle together with the shuttle vehicle and this first container can travel in the aisle to a transfer station and deliver the container, for example, to an intermediate conveyor. If, however, the first container of the channel is not the container to be retrieved, the shuttle vehicle first pushes the first container from the aisle into another channel in which at least one storage position is free. Subsequently, the preceding steps are repeated until the container to be retrieved is located on the aisle vehicle, which is then driven in the aisle to a transfer station and delivers the container, for example, to an intermediate conveyor.

For storing a container in the rack, an aisle vehicle together with a shuttle vehicle arranged thereon and the container to be stored is moved in the aisle to the end of the channel facing the aisle into which the container is to be stored. Subsequently, the shuttle vehicle together with the container to be stored is moved from the aisle vehicle into the channel, whereby any containers already located in the channel are pushed within the channel away from the aisle, i.e. uphill, and the shuttle vehicle deposits the container to be stored on the storage position closest to the aisle.

If the rack has a plurality of levels arranged one above the other, an additional step may be required in which the container to be stored or retrieved is transported vertically by means of a lift.

If, for example, a separate shuttle vehicle with a lifting device is provided, the shuttle vehicle can perform a wake-up function for containers that have become stuck in the channel. In this case, the shuttle vehicle travels uphill until it encounters the stuck container with its lifting device in theof the channel slightly back uphill. After this wake-up operation, the containers located behind the shuttle vehicle can roll back down in a controlled manner to the valley, i.e. to the end of the channel.

The invention will be explained hereinafter with reference to the accompanying schematic drawing. It shows:

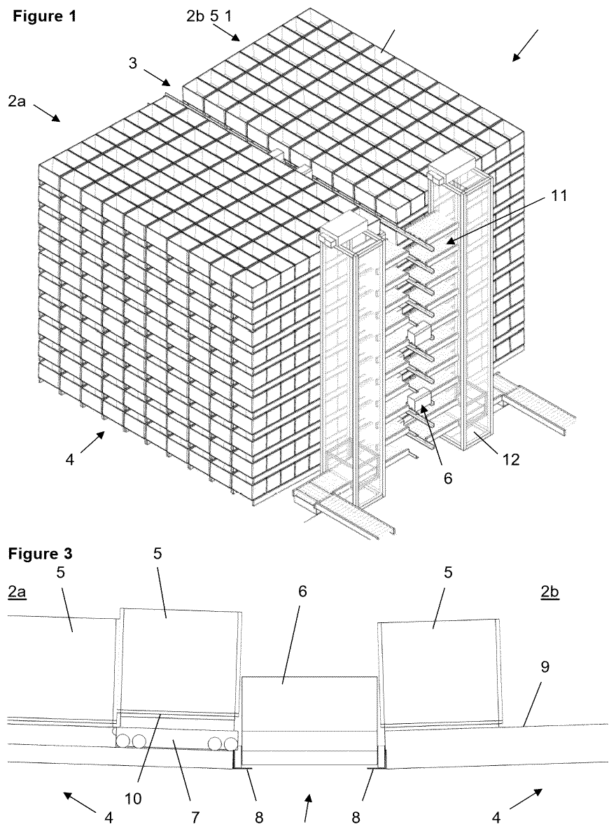

FIG. 1 a perspective view of a storage system according to the invention,

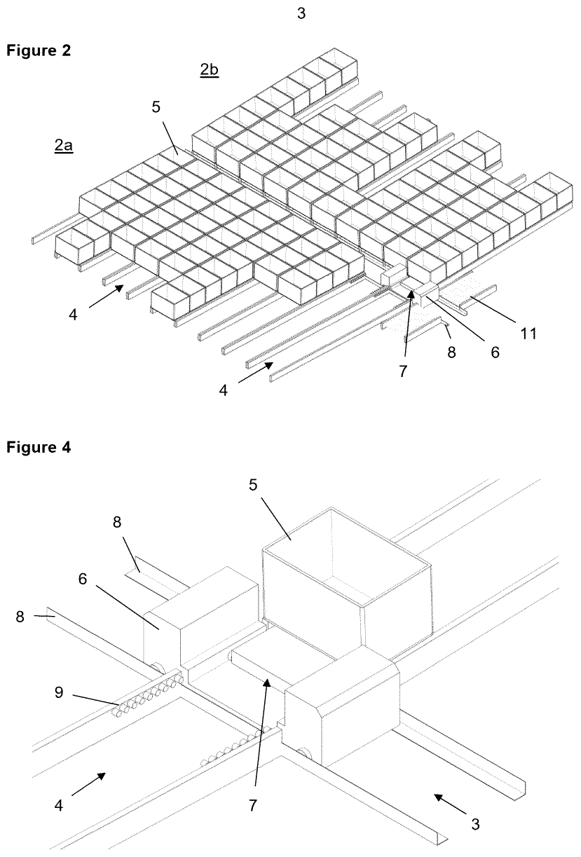

FIG. 2 in partial view, one level of the storage system according to FIG. 1,

FIG. 3 in partial view, a portion of one level of the storage system according to FIG. 1, and

FIG. 4 a detailed view of a portion of one level of the storage system according to FIG. 1.

A purely exemplary embodiment of a storage system 1 according to the invention, designated by reference numeral 1, is illustrated in FIGS. 1 to 4. The storage system comprises at least one rack, wherein in the example shown in the figures two racks 2a, 2b are provided, which are arranged on both sides of a central aisle 3.

Each rack comprise one or, preferably, a plurality of vertically one above the other. In the example of FIG. 1, each of the two racks 2a. 2b comprises ten levels arranged one above the other. In each level, a plurality of channels 4 may be provided, wherein in the illustrated example ten channels 4 are provided in each level.

Each of the channels 4 is designed to receive at least one container 5. In the Illustrated example, as shown in FIG. 2, up to nine containers 5 can be arranged in each channel 4. With regard to operating times, it has proven to be particularly advantageous if each channel 4 can accommodate between five and ten containers 5. As can be seen in particular from FIG. 3, the channels 4 are orientated at an inclination of about 1.8° relative to the horizontal, such that the end of each channel 4 facing the aisle 3 lies vertically below the end of the corresponding channel 4 facing away from the aisle 3. The number, arrangement, and size of the levels and channels can be flexibly adapted according to the storage requirements.

On each level, an aisle vehicle 6 can travel along aisle 3. It is preferred if each level has a separate aisle vehicle 6. Alternatively, it is also possible to move aisle vehicles 6 vertically between the levels, so that a single aisle vehicle 6 can, for example, serve two levels.

In the embodiment shown, the aisle vehicle 6 is equipped with a shuttle vehicle 7. which can be moved together with the aisle vehicle 6 along the aisle 3. It is also possible to move the shuttle vehicle 7 relative to the aisle vehicle 6 into individual channels 4. For this purpose, the shuttle vehicle 7 may be provided with a suitable drive system, for example a gear drive that engaging with rack rails on the channel side (not shown), which is capable of moving a sufficient number of containers 5 against gravity, i.e. uphill, within the channel 4.

In the embodiment example shown, a pair of rails 8 is provided in the aisle 3 of each level, on which the aisle vehicle 6 can travel. The rails 8 may form part of a power supply for, for example, the electric drive of the aisle vehicle 6 and/or carry lines for the power supply and, where appropriate for the control of the aisle vehicle 6.

The individual channels 4 are preferably designed in such a way that the containers 5 can slide, slip or roll within the channels with the least possible resistance.

In the example shown, the channels 4 are equipped with roller tracks 9, so that the containers 5, due to the inclination of the channels 4, move under the influence of gravity within the channels 4 toward the aisle 3, i.e. downhill, by rolling or sliding. A stop, not shown in detail, may prevent the containers 5 from rolling into the aisle 3. Accordingly, in FIG. 2, the channels 4, insofar as containers 5 are present therein, are always filled with containers 5 on the side facing the aisle 3, and any free spaces in the respective channels 4 are located at the end facing away from the aisle 3.

The shuttle vehicle 7 comprises, for example, a lifting device 10 for raising a container 5 within a channel 4. In this way, it is possible to remove the container 5 closest to the aisle 3 from the respective channel 4, or to deposit a container 5 in a channel 4.

In the example shown in the figures, a conveyor belt 11 is provided at one end of each level of each rack 2a, 2b, which forms an intermediate conveyor. The shuttle vehicle 7 can use the lifting device 10 to set down from the aisle vehicle 6 onto the conveyor belt 11, or to pick up containers 5 from the conveyor belt 11 onto the aisle vehicle 6. The conveyor belt 11 can also be used as an intermediate buffer for temporarily storing one or more containers 5.

Furthermore, in the example shown each shelf 2a, 2b is provided with its own lift 12, which connects the individual levels of the tracks with one another in the vertical direction. Alternatively, a single lift 12 may also serve both racks 2a, 2b. Preferably, the conveyor belts 11 are interposed between the aisles 3 of each level and the lift 12.

In order to remove a specific container 5 from the storage system 1 according to the invention, an aisle vehicle 6 together with a shuttle vehicle 7 arranged thereon is driven, by a control system not shown, within the corresponding level in which the container 5 is stored, along the aisle 3 to the channel 4 in which the container 5 is stored. The shuttle vehicle 7 can then, by means of the lifting device 10, pick up the container 5 closest to the aisle 3 and transfer it onto the aisle vehicle 6.

If the container 5 loaded onto the aisle vehicle 6 in this way is already the container to be removed, the aisle vehicle 6 can transport the container 5 to the conveyor belt 11, where the shuttle vehicle 7 transfers the container 5 onto the conveyor belt 11, from which it may then be conveyed, if necessary, by means of the lift 12, to an transport track for further removal.

If, on the other hand, the container 5 to be removed is not the container located closest to the aisle 3 within the channel 4, the channel 4 must first be cleared until the container 5 to be removed is at the position of the channel 4 closest to the aisle 3. For this purpose, the container located closest to the aisle 3 is first removed from the channel 4 and placed either in another channel 4 of the storage system 1 or onto the conveyor belt 11. This process is repeated until the container 5 to be removed is the container located closest to the aisle 3 in the channel 4, and can then be transported away as described above.

The storage of a container 5 in a channel 4 is carried out by means of the aisle vehicle 6 and the shuttle vehicle 7. For this purpose, the shuttle vehicle 7 loaded with the container 5 is driven into the channel 4, whereby any containers 5 already present in the channel 4 are displaced against gravity, i.e. uphill, away from the aisle 3 within the channel 4, so that a storage space for the container 5 is freed at the end of the channel 4 facing the aisle 3. There, the container can then be set down by means of the lifting device 10, and the shuttle vehicle 7 is returned onto the aisle vehicle 6.

In this way, containers 5 jammed in a channel 4, which no longer roll or slide automatically to the end of the channel 4 facing the aisle 3, can also be displaced by means of the shuttle vehicle 7, optionally with the lifting device 10 extended, until they are free again.

### REFERENCE SIGNS

1 Storage system
2a, b Rack1
3 Aisle
4. Channel
5 Container
6 Aisle vehicle
7 Shuttle vehicle
8 Rail
9 Roller conveyor
10 Lifting device
11 Intermediate conveyor (conveyor belt)
12 Lift

1. Automated storage system with
at least one rack (2a, 2b) which is arranged parallel to an aisle (3) and comprises at least one level with a plurality of channels (4) arranged transversely to the aisle (3), wherein the channels (4) are inclined relative to the horizontal in such a way that the end of each channel (4) facing the aisle (3) lies vertically below the end of the respective channel (4) facing away from the aisle (3),
at least one aisle vehicle (6) movable in the aisle (3) and positioned near the ends of the channels (4) facing the aisle (3) for retrieving containers (5) from the channels (4), and
a control unit for the autonomous movement of the at least one aisle vehicle (6),
Characterized in that, the aisle vehicle (6) comprises a shuttle vehicle (7) which is designed and configured to store containers (5) into the channels (4) by moving relative to the aisle vehicle (6) and transversely to the aisle (3) into the channels (4).

2. Automated storage system according to claim 1, characterized in that each channel (4) comprises at least one rack extending transversely to the aisle (3), and that the shuttle vehicle (7) includes at least one drivable gear for engaging with the rack of the respective channel (4).

3. Automated storage system according to claim 1, characterised in that the channels (4) are inclined relative to the horizontal by 1° to 3°, in particular by approximately 1.8°.

4. Automated storage system according to claim 1, characterised in that the length of the channels (4) is adapted to the size of the containers (5) to be stored and retrieved in such a way that each channel (4) can accommodate between five and ten containers (5).

5. Automated storage system according to claim 1, characterised in that the channels (4) are designed as roller tracks (9), rollerconveyors and/or ball tracks.

6. Automated storage system according to claim 1, characterised in that rails (8) run parallel to the aisle (3) in each level, on which rails the aisle vehicle (6) is movable.

7. Automated storage system according to characterised in that at least one intermediate conveyor, such as a conveyor belt (11), extending transversely to the aisle (3) is provided in each level.

8. Automated storage system according to claim 1, wherein the rack (2a, 2b) comprises several levels arranged one above the other, characterised in that at least one lift (12) is provided, which is designed and configured to move containers (5) between the levels.

9. Automated storage system according to claim 1, characterised in that the shuttle vehicle (7) is connected to the aisle vehicle (6) via a power supply and/or signal line.

10. Automated storage system according to claim 1, characterised in that the aisle vehicle (6) is connected to an energy source via conductor rails.

11. Automated storage system according to claim 1, characterised in that the shuttle vehicle (7) comprises a lifting device (10) by means of which a container (5) can be lifted for storing and/or retrieving within a channel

12. Automated storage system according to claim 1, characterised in that a rack (2a, 2b) is provided on each side of the aisle (3), wherein the channels (4) of both racks (2a, 2b) are inclined relative to the horizontal in such a way that the end of each channel (4) facing the aisle (3) lies vertically below the end of the respective channel (4) facing away from the aisle (3), and wherein the shuttle vehicle (7) is movable into the channels (4) of both racks (2a, 2b).

13. Method for storing and retrieving containers in an automated storage system (1) according claim 1,
wherein for retrieving a container (5) from the rack (2a, 2b)
a) an aisle vehicle (6) together with a shuttle vehicle (7) arranged thereon, is moved in the aisle (3) to the end of the channel facing the aisle (3), in which the container (5) to be retrieved is located,
b) the shuttle vehicle (7) is moved from the aisle vehicle (6) into the channel (4) where it picks up the first container (5) of the channel (4) closest to the aisle (3) and is then moved back together with this first container (5) onto the aisle vehicle (6),
c1) if the first container is the container (5) to be retrieved, the aisle vehicle (6) is moved with the shuttle vehicle (7) and the first container in the aisle (3) to a transfer station, or
c2) if the first container is not the container (5) to be retrieved, the shuttle vehicle (7) first pushes the first container from the aisle (3) into another channel (4) in which at least one storage location is free, and then repeats steps a) and b),
and wherein for storing a container (5) in the rack (2a, 2b)
d) an aisle vehicle (6) together with a shuttle vehicle (7) arranged thereon and the container (5) to be stored, is moved in the aisle (3) to the end of the channel (4) facing the aisle, into which the container (5) is to be stored,
e) the shuttle vehicle (7) together with the container (5) to be stored, is moved from the aisle vehicle (6) into the channel (4), wherein any containers (5) already located in the channel (4) are pushed further inside the channel (4) away from the aisle (3), and the container (5) to be stored is deposited in the storage location closest to the aisle (3).

14. Method according to claim 13, which, if the rack (2a, 2b) comprises several levels arranged one above the other, includes, as an additional step after step c1) or before step d) the vertical transport of the container (5) to be stored or retrieved by means of a lift (12).

15. Method according to claim 13-14, characterised in that the shuttle vehicle (7) provided with a lifting device (10), when one of the containers (5) is jammed in a channel (4), extends the lifting device (10) and moves into the channel (4) until the lifting device (10) of the shuttle vehicle (7) hits the jammed container (5), and subsequently pushes this containers (5) and any further containers (5) in the channel (4) uphill.
